(19) United States
(12) Patent Application Publication
(10) Pub. No.: US 2006/0050041 A1
(43) Pub. Date: Mar. 9, 2006

(54) Liquid-crystal active maxtrix array device

(76) Inventors: Martin J Edwards, Crawley (GB); John R.A Ayres, Reigate (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/529,170

(22) PCT Filed: Sep. 12, 2003
(86) PCT No.: PCT/IB03/03976

§ 371 Date: Mar. 24, 2005

(30) Foreign Application Priority Data
Sep. 27, 2002 (GB) 0222448.3
Oct. 15, 2002 (GB) 0223957.2

(51) Int. Cl. G09G 3/36

(52) U.S. Cl. 345/98

(57) ABSTRACT

An active matrix array device has driver circuitry for providing address signals to the matrix elements and which includes digital to analogue converter circuitry. The driver circuitry is arranged alongside one edge of the array of matrix elements, and comprises a multiple voltage level generator circuit providing a plurality of analogue voltage levels for addressing the matrix elements, with the plurality of levels being provided on outputs distributed substantially along the length of the one edge. A group of switches is associated with, and located at, each output of the voltage level generator circuit and provides signals to an output bus arranged alongside the one edge and having the first number of lines. This architecture enables a reference voltage bus line to be removed by interleaving the voltage selection switches.

This invention relates to active matrix array devices, and in particular to active matrix devices in which digital to analogue converter circuitry is provided for generating the drive signals for the individual device pixels. For example, the invention relates to display devices. In typical display configurations, these drive signals are provided to columns of pixels, and the digital to analogue converter circuitry is then part of the column driver circuitry.

The use of resistor string digital to analogue converters is known in the column driver circuitry of active matrix liquid crystal (LC) displays. A single resistor string is typically used to supply a large number of converter circuits, as this ensures good uniformity of the output voltages of the converters. The resistor string comprises a resistor or a set of resistors connected in series with connections being made at various points along the length of the string. A voltage is applied to each end of the resistor string, and in addition voltages may also be applied to intermediate points along the string. The outputs are taken from various points along the length of the string and the voltages present at these points represent the analogue output voltage levels of the digital to analogue converters. These voltages may be distributed evenly across the voltage range in order to produce a converter with a linear output voltage characteristic, or they may be arranged to produce a non-linear characteristic which matches the electro-optical characteristics of the liquid crystal.

This nonlinearity can be achieved by changing the value of resistance between the points where outputs are taken from the resistor string and by modifying the values of the voltages applied to points within the resistor string.

When digital to analogue converter circuits with shared resistor strings are used in crystalline silicon drive integrated circuits (ICs) for active matrix liquid crystal displays (AMLCDs), a separate digital to analogue converter is normally associated with each column drive output.

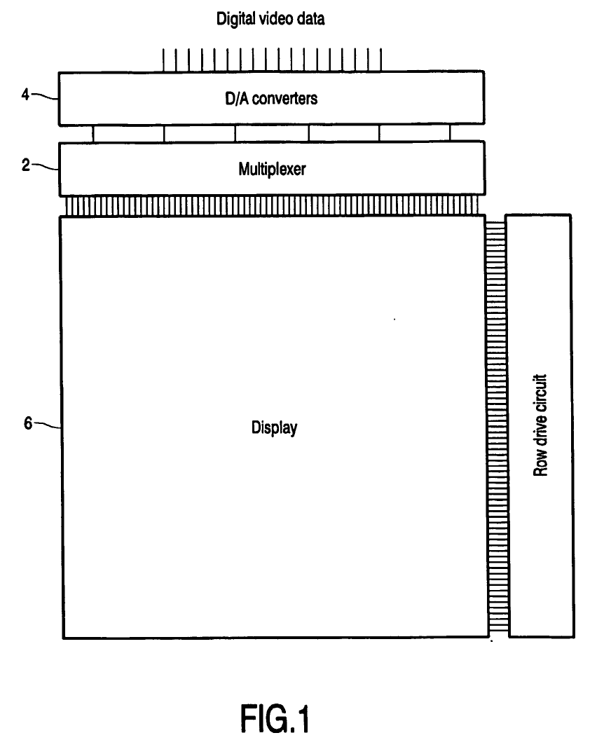

It has been proposed to integrate the digital to analogue converters and the resistor string or strings onto the substrate of the display using thin film circuitry. It has also been proposed to apply the output signals from the digital to analogue converters to a multiplexer circuit as illustrated in FIG. 1.

The multiplexer circuit 2 allows the output of each converter circuit 4 to be connected to one of a number of columns in the display 6. The use of a multiplexer circuit 2 simplifies the circuitry which must be integrated on the display substrate, since it is no longer necessary to provide latches for the digital data and a digital to analogue converter for each column in the display. A potential disadvantage of the multiplexed approach is that since each converter circuit supplies the signals for more than one column they must be operated at a higher speed with shorter conversion times. The converter and multiplexer circuits are arranged across the width of the display in order to minimise the extension of the display substrate beyond the active area of the display.

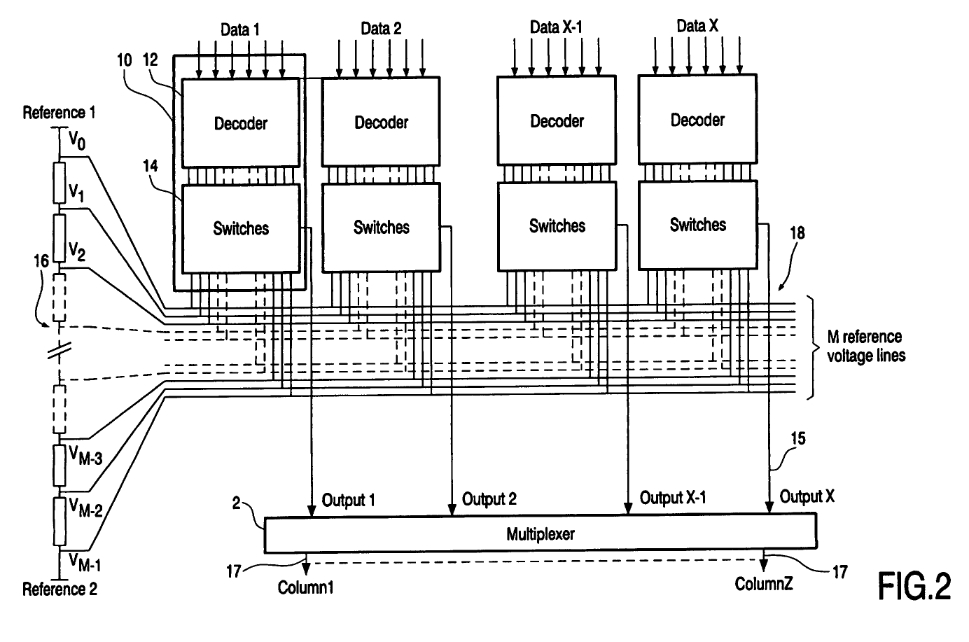

A possible circuit arrangement consisting of a number X of converters is shown in FIG. 2. Each digital to analogue converter 10 consists of a decoder 12 and a set of voltage selection switches 14. A resistor string 16 is used to generate the required number, M, of analogue reference voltages. Number M is related to the number of bits N in the digital input (“Data1”-“DataX”) by the equation M=2^{N}. The reference voltages are supplied to the digital to analogue converter circuits using a reference voltage bus 18 consisting of M lines.

The X converter outputs 15 are supplied to a multiplexer circuit 2 which routes the X outputs to a selected group of the Z columns 17 (where Z is equal to the number X multiplied by the multiplex ratio of the multiplexer 2).

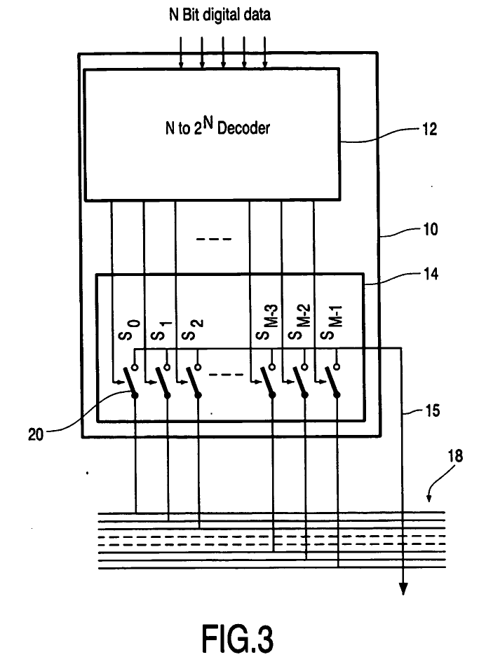

The operation of the converter circuits is illustrated by FIG. 3, which shows in more detail the arrangement of the voltage selection switches 14. A respective switch 20 is connected between each of the M reference voltage inputs from the reference voltage bus 18, and the output 15 of the converter circuit 10. The switches 20 are controlled by the M outputs of an N to 2^{N} decoder circuit 12. When the digital data is applied to the inputs of the decoder, only one of the decoder outputs becomes selected, turning on the switch to which it is connected and applying a selected one of the reference voltages from the bus 18 to the output of the converter. Of course, the switch and the decoder circuit functions shown in FIG. 3 could be implemented in a number of different ways, and the decoder and switching functions might be combined within a single circuit.

This circuit arrangement has been proposed for integrated column drive circuits for low temperature poly-Si AMLCDs for a low number of bits of digital data (corresponding to a relatively low number of grey levels in the displayed images), for example 4 bits or 16 grey levels. However, there is a need to increase the grey scale capability of the displays to 6 or 8 bits.

The circuits described above present particular problems as the number of bits of digital data increases. For example, a 6 bit converter circuit has 64 possible output voltage levels and therefore requires 64 reference voltage lines to distribute the voltages to the converter circuits. These lines will occupy a significant area on the substrate of the display and will add significantly to the capacitance present at the nodes of the resistor string. The effect of this additional capacitance could conceivably be compensated for, by decreasing the values of the resistors used within the resistor string, but this would increase the power consumption of the display, which is undesirable. If the resistance of the resistor string is not reduced then the effect of the additional capacitance is to increase the time required for the output voltages of the converter circuits to settle at their correct values, increasing the number of converter circuits required to address the columns of the display (because the multiplexing ratio would have to be reduced).

This can be understood further by considering the sequence of events required to charge a particular column in the display. Appropriate digital data is applied to the data input of the digital to analogue converter, and the multiplexer circuit connects the output of the converter circuit to the column electrode. The voltage initially present on the column capacitance will not normally be the same as the required output voltage of the converter circuit. Thus, a charging circuit is formed in which the column capacitance is connected to a particular point within the resistor string through a switch within the multiplexer circuit 2 and a switch 20 within the digital to analogue converter 10. It is desirable that the resistance of the switches is relatively low compared to the resistance of the string. As a result, the voltage present on the resistor string will be disturbed from the desired value by virtue of the connection of one point within the resistor string to the column capacitance. Time must be allowed for the voltage on the resistor string to return to its correct value and for the column capacitance to charge to the required voltage. The time required for this depends on the values of the various capacitances and resistances which make up the charging circuit, and these include the resistance of the resistor string, the capacitance and resistance of the voltage reference bus lines 18 and the capacitance of the column electrode. It is desirable to use the highest possible value of resistance for the resistor string in order to reduce the power consumed in the reference voltage sources, and to minimise the resistance and capacitance of the reference voltage bus lines.

The need for all voltage reference lines to extend across the column driver requires them to be closely spaced and as narrow as possible, otherwise the substrate area required to accommodate the bus lines increases. These requirements are of course incompatible with minimising resistances and capacitances, to avoid the RC time constant of the bus becoming too large.

According to the invention, there is provided an active matrix array device comprising an array of individually addressable matrix elements and driver circuitry for providing address signals to the matrix elements, the driver circuitry including digital to analogue converter circuitry for providing a first number of outputs for application in parallel to a corresponding first number of matrix elements, wherein the driver circuitry is arranged alongside one edge of the array of matrix elements, and comprises:
a multiple voltage level generator circuit providing a plurality of analogue voltage levels for addressing the matrix elements, the plurality of levels being provided on outputs distributed substantially along the length of the one edge;
a group of switches associated with, and located at, each output of the voltage level generator circuit; and
an output bus arranged alongside the one edge and having the first number of lines, the group of switches selectively coupling the associated voltage level generator circuit output to each line of the output bus.

In this architecture, it is possible to eliminate the reference voltage bus lines. This is achieved by interleaving the voltage selection switches. An output bus is required, but the number of output bus lines is lower than the number of analogue levels. In particular, for large digital words (for example 6 or 8 bit) there are many voltage levels. The number of output lines may correspond to the number of columns in an array arranged in rows and columns, but it may be a significantly smaller number if multiplexing is also used. Thus, the space occupied by the output bus is less than the reference voltage bus and/or lower resistance conductors can be used.

In this description and in the claims, the term “alongside” (in connection with an edge of the matrix array) does not signify any particular proximity, but merely indicates that space beyond that edge is used for the positioning of the circuit concerned.

The multiple voltage level generator circuit may comprise a resistor string extending alongside the length of the one edge. The intermittent points are then at distributed locations alongside the edge.

Each group of switches preferably comprises a switch associated with each output bus line, so that each group of switches is for controlling the switching of one of the reference voltages to each output line, in the same proximity. The switches of each group are then controlled by a corresponding bit (i.e. the bit corresponding to that voltage level) of digital words based on the digital inputs to the digital to analogue converter circuitry. These digital words preferably comprise the expansion of n-bit digital inputs to the digital to analogue converter circuitry into 2ⁿ bit words having a single non-zero bit. The single non-zero bit then identifies which voltage level is to be applied to the output.

A multiplexer circuit may be provided for switching the first number of outputs to a selected first number of matrix elements. This reduces the number of lines in the output bus (compared to the total number of matrix element control signals required). For example, the array of matrix elements may be arranged in rows and columns, and the driver circuitry is arranged alongside a column edge of the array, and the multiplexer circuit then switches the first number of outputs to a selected subset of the columns. This is carried out in turn to enable all of the columns to be addressed with a reduced number of address signals.

The multiplexer circuit may include the output bus together with switching elements which connect to the output bus and to each column. The output bus can thus be shared between the converter circuitry and the multiplexing circuitry.

As mentioned above, decoder circuitry can be provided for converting n-bit digital inputs to the digital to analogue converter circuitry into 2ⁿ bit words having a single non-zero bit. This single bit then provides the selection of the desired output level. This decoder circuitry can be distributed along the length of the one edge and then receives the first number of n-bit digital inputs, and generates the first number of 2ⁿ bit digital outputs, with corresponding bits of each of the first number of 2ⁿ bit digital outputs spatially grouped together. In this way, the decoder circuitry as well as the switching circuitry of the digital to analogue converter circuit can be distributed along the edge.

The device may comprise an active matrix liquid crystal display, and the driver circuitry may be integrated onto the same substrate as the array of matrix elements.

Examples of the invention will now be described in detail with reference to the accompanying drawings, in which:

FIG. 1 shows a known display configuration;

FIG. 2 shows a known arrangement for the D/A converters of FIG. 1;

FIG. 3 shows in greater detail the circuitry of FIG. 2;

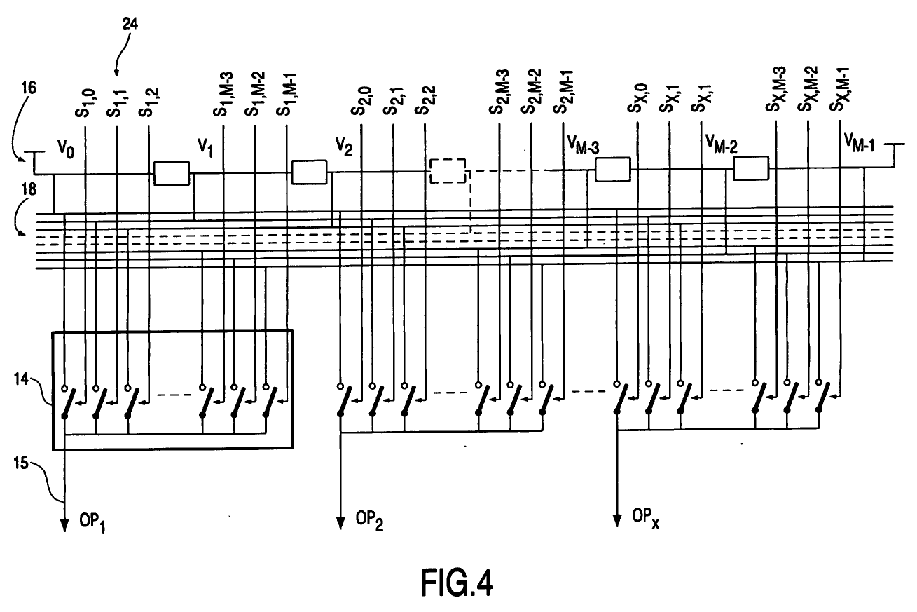

FIG. 4 shows one possible further implementation of the D/A converter circuitry;

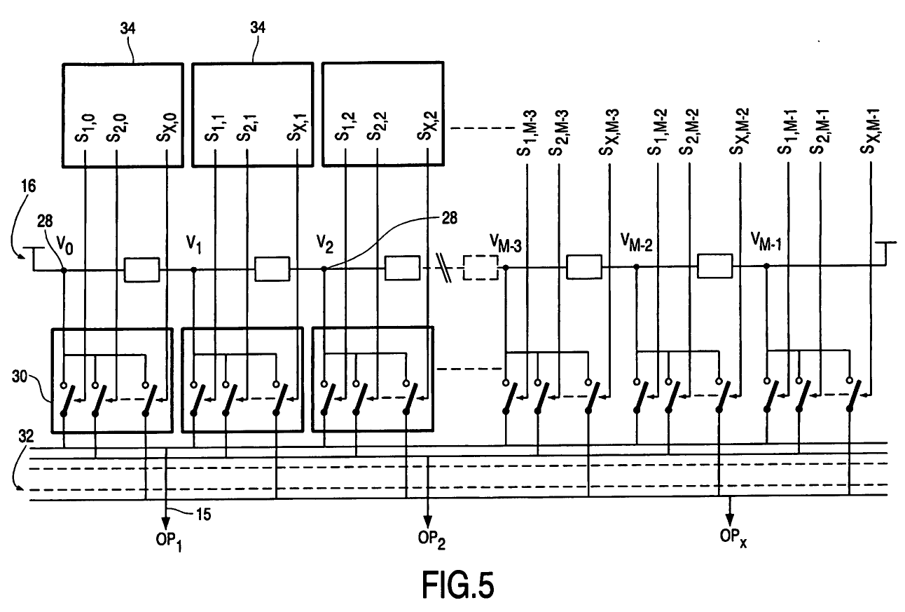

FIG. 5 shows a first example of implementation of the D/A converter circuitry in accordance with the invention;

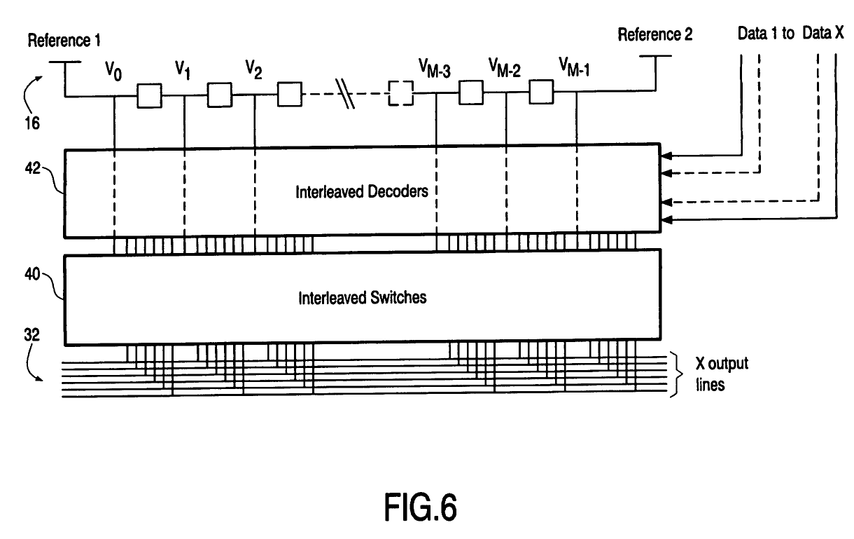

FIG. 6 shows a second example of implementation of the D/A converter circuitry in accordance with the invention;

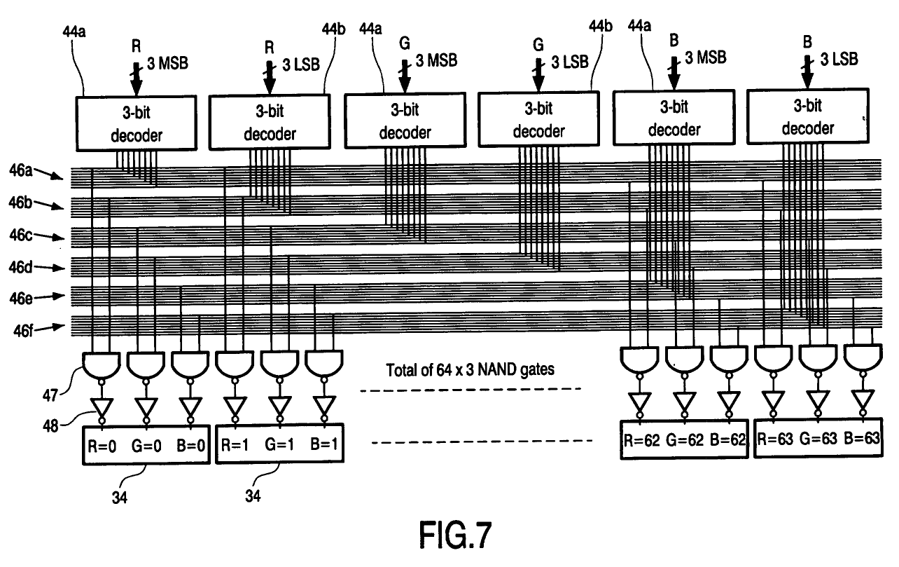

FIG. 7 shows how the decoder circuits may be interleaved; and

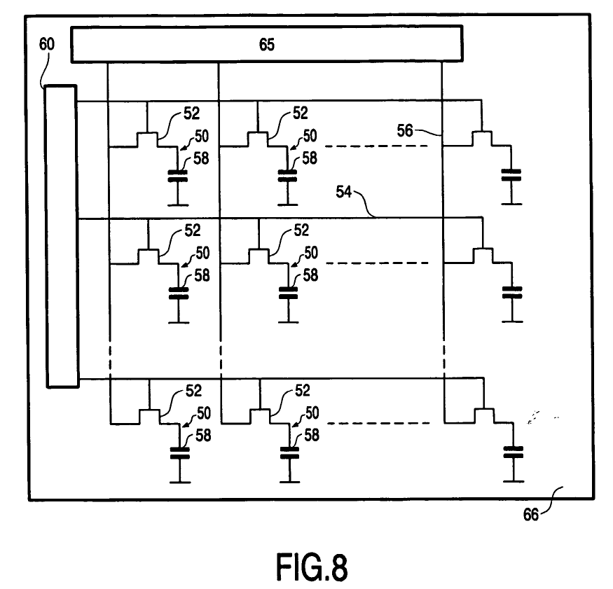

FIG. 8 shows a display which may use column driver circuitry of the invention.

FIG. 4 shows in greater detail one possible implementation of the known circuit of FIG. 3. The switches 14 of each digital to analogue converter are grouped, with each group having the switches associated with one output 15. Each group of switches 14 receives a digital word 24 comprising the input for that particular digital to analogue conversion—this is the output of the decoder 12. Thus, the digital to analogue converters are provided as discrete sets of components. In FIG. 4, the resistor string 16 is spread along the length of the driver circuitry, but there needs to be a reference voltage bus 18 to provide all of the voltage levels to each converter circuit.

FIG. 5 shows an arrangement in accordance with the invention. The driver circuitry again includes digital to analogue converter circuitry for providing a first number X of outputs 15 for application in parallel to a corresponding first number of columns of the matrix array.

As in the example of FIG. 4, the resistor string 16 provides a plurality of analogue voltage levels V₀-V_{M-1} to be used for addressing the matrix elements (e.g. display elements). The reference voltage level outputs 28 are again provided distributed along the length of the driver circuitry, which as in FIG. 1, is to be located alongside one edge, typically a column, of the array.

The converter circuitry again includes switches which essentially connect a selected analogue voltage level to an output. Any one output 15 is connected to only one analogue voltage V₀-V_{M-1} through a switch. However, in accordance with the invention, the switches are arranged in groups 30, with each group 30 associated with, and located at, an output of the resistor string. An output bus 32 is arranged parallel with the resistor string and has a number of output lines corresponding to the number of outputs 15 provided by the circuit, namely the number of conversions carried out in parallel by the circuit. Each group 30 of switches selectively couples the associated one of the voltage levels V₀-V_{M-1} to each line of the output bus. Each group 30 may couple the voltage level to none, one or more of the output lines, depending on the digital input.

This architecture eliminates the reference voltage bus line 18 of FIG. 4 by interleaving the voltage selection switches. The switches within the converter circuits which are associated with the same reference voltage level are formed into the groups 30 and take their input directly from the resistor string. This avoids the need for a reference voltage bus to distribute the reference voltages between the converter circuits and therefore minimises the capacitance which is directly connected to the resistor string. In effect, the switches which form the converter circuits within this arrangement are interleaved in terms of their layout on the substrate.

The control of the groups of switches 30 is performed using digital words as explained with reference to FIG. 3. Thus, each digital input is converted into a word in which all bits are zero apart from one bit, which identifies the analogue voltage level to be applied. This conversion is again an expansion of n-bit digital inputs into a 2ⁿ bit words. The single non-zero bit then identifies which voltage level is to be applied to the output.

The control signals 34 for each group of switches comprise one of the bits, but for all of the digital inputs being converted. Thus, the switches associated with a particular converter circuit (in other words associated with a particular digital input) will be widely separated on the substrate, in particular distributed across the width of the display within the column drive circuit, with one switch within each group 30. The outputs of the switches must be joined together to form the outputs of the converter circuits, and hence the need for the output signal bus 32.

The capacitance of these output bus lines contributes to the capacitance seen by the resistor string. However, the number of output bus lines will typically be much lower than the number of voltage reference lines that would be required in the previous circuit architecture.

The outputs 15 are again provided to a multiplexer circuit (not shown in FIG. 5). This reduces the number of lines in the output bus compared to the total number of columns. The multiplexer circuit may require an input bus structure in which case it may be possible to use the same bus lines for connecting the output switches of the converter circuits and the multiplexing switches of the multiplexer circuit.

A further aspect of the new circuit arrangement is shown in FIG. 6. As discussed above, the switches associated with the different converter circuits are effectively interleaved to provide the block 40. It is also advantageous to interleave the circuits associated with the decoders to provide the block 42. In principle, the decoder circuits could be formed as discrete blocks on the display substrate, but this would require the output signals of the decoders to be distributed over a significant distance to the voltage selection switches 40. Since the number of output signals from the decoders is much greater than the number of input signals (as there is an n to 2ⁿ conversion), it is preferable to interleave the decoder circuits even though this means that the input data must be distributed over a larger area of the substrate.

This decoder circuitry thus groups together corresponding bits of each of the 2ⁿ bit digital outputs. In this way, the decoder circuitry as well as the switching circuitry of the digital to analogue converter circuit can be distributed along the edge of the matrix array.

FIG. 7 shows in more detail a partially interleaved decoder design, which is for converting a 6 bit digital input into a 64 bit word, with only one of the bits a logical “1” for identifying a desired voltage level. FIG. 7 essentially shows three decoders, one for each colour-red “R”, green “G” and blue “B”. Thus, the decoder of FIG. 7 may be considered as one example of decoder for producing the outputs as arranged in FIG. 5, with X=3.

For each colour (i.e. value of X), the 6 bit digital word is provided to two 3 bit decoders 44a, 44b, each of which provides 8 output lines. These 3 bit decoders are not interleaved, and they are discrete components as shown. The 8 outputs from each decoder 44a, 44b are provided to a respective bus 46a-46f which extends across the width of the column driver circuitry. The remaining circuitry of the decoder is then interleaved, as explained below.

As shown in FIG. 5, the decoder outputs are grouped into groups 34 corresponding to the same desired voltage level.

Each decoder output can be derived from the combination of a selected two of the 3 bit decoder 44a,44b outputs. For example, the lowest voltage level will be selected if the first bit of the MSB decoder is the “1” and the first bit of the LSB decoder is the “1”. Thus, the lowest level is defined by the 6 bit digital word if:
LSB_{LSBdecoder} AND LSB_{MSBdecoder}=1

As shown in FIG. 7, the LSB from the two decoders is provided to an AND gate (implemented in practice as a NAND gate 47 and a NOT gate 48). This is carried out for all three values of X—namely all three colours.

The data for all 64 voltage levels can be obtained in this way, by providing to the corresponding AND gate the two outputs of the LSB and MSB decoders which need to be “1” for that voltage level to be defined by the 6 bit digital input.

The architecture in FIG. 7 thus interleaves the AND gates so that the decoder outputs are grouped in the manner explained with reference to FIG. 5. It will be appreciated that the components of the discrete decoders 44 can also be distributed across the width of the circuitry if desired.

The invention is most applicable to active matrix liquid crystal displays. Such devices will now be described in slightly greater detail. Referring to FIG. 8, the active matrix LC display device (AMLCD) comprises a row and column array of individually operable liquid crystal display elements 50. The display elements each have an associated TFT 52 acting as a switching device and are addressed by peripheral addressing circuitry via sets of row and column address conductors 54 and 56 and comprising a row drive circuit 60 and a column drive circuit 65 connected respectively to the sets of row and column conductors. The column driver circuit includes the digital to analogue converter circuits and the multiplexing circuits, and the circuits described above can be contained within the column drive circuit 65 shown schematically in FIG. 8.

Only a few typical display elements are shown for simplicity but in practice there would normally be at least several hundred rows and columns of such elements. The drain of a TFT 52 is connected to a respective display element electrode 58 situated adjacent the intersection of respective row and column address conductors, while the gates of all the TFTs associated with a respective row of display elements 50 are connected to the same row address conductor 54 and the sources of all the TFTs associated with a respective column of display elements are connected to the same column address conductor 56. The sets of row and column address conductors 54, 56, the TFTs 52, and the picture element electrodes 58 are all carried on the same insulating substrate 66, for example of glass, and fabricated in conventional manner using known thin film technology involving the deposition and photolithographic patterning of various conductive, insulating and semiconductive layers.

A second glass substrate, (not shown) carrying a continuous transparent electrode common to all display elements in the array is arranged spaced from the substrate 66 and the two substrates are sealed together around the periphery of the display element array and separated by spacers to define an enclosed space in which liquid crystal material is contained. Each display element electrode 58 together with an overlying portion of the common electrode and the liquid crystal material therebetween defines a light-modulating capacitive display element.

Both the general structure and operation of this device follow conventional practice. Scanning (gating) signals are applied to each row address conductor 54 in turn by the row driver circuit 60, comprising for example a digital shift register, and data signals are applied to the column conductors 56, in synchronisation with the gating signals, by the column drive circuit 65. Upon each row conductor being supplied with a gating signal, the TFTs 52 connected to that row conductor are turned on causing the respective display elements to be charged according to the level of the data signal then existing on their associated column conductors. Upon termination of the gating signal at the end of the respective row address period, corresponding for example to the line period of an applied video signal, the associated TFTs are turned off for the remainder of the field period in order to isolate electrically the display elements and ensure the applied charge is stored on the LC capacitance to maintain their display outputs until they are addressed again in a subsequent field period.

The row and column drive circuits 60 and 65 are both integrated on the substrate 66 with their circuitry being formed simultaneously with the fabrication active matrix array using the same thin film technology and similarly comprising TFTs, conductor lines, capacitors, etc. The row drive circuit 60 is of conventional form, comprising for example a simple shift register circuit whose operation is controlled by timing signals provided by an external timing and control circuitry (not shown) to which digital video data is supplied from a suitable source.

The digital video information (data) signals are supplied by the timing and control circuitry to the column drive circuit 65 which operates to apply to the set of conductors 16 analogue voltage signals derived from this data in parallel (or in groups in the multiplexed case) for each row of display elements in turn so as to produce the desired display effects from the displays element in each row according to the supplied data.

The multiplexing circuit includes multiplexing switches which may consist of NMOS TFTs, PMOS TFTs or CMOS transmission gates. The switches, which each constitute an output of the circuit associated with a respective column conductor, are operated in groups and when a group of switches is turned on the corresponding columns are charged according to the data signal voltage levels then existing on the respective associated video bus lines. When the switches turn off the voltages on the column conductors are stored on the capacitance of the column conductors and any additional storage capacitors which may be connected in parallel with them. During a respective video line, row address, period each group of multiplexing switches is turned on in sequence until all of the columns of display elements have been charged with the appropriate video information.

The invention is particularly applicable to active matrix displays where the drive circuits are integrated on the display substrate using TFTs, and the invention may be particularly suitable for small active matrix liquid crystal displays.

The specific examples above relate to active matrix liquid crystal displays, and indeed this is the preferred use of the invention. However, the invention can be applied to other types of display device and indeed other array devices in which an analogue address signal is required.

From reading the present disclosure, other modifications will be apparent to persons skilled in the art. Such modifications may involve other features which are already known in the field of active matrix array devices and component parts thereof and which may be used instead of or in addition to features already described herein.

1. An active matrix array device comprising an array of individually addressable matrix elements and driver circuitry for providing address signals to the matrix elements, the driver circuitry including digital to analogue converter circuitry for providing a first number (X) of outputs for application in parallel to a corresponding first number of matrix elements, wherein the driver circuitry is arranged alongside one edge of the array of matrix elements, and comprises:
a multiple voltage level generator circuit providing a plurality of analogue voltage levels (V₀-V_{M-1}) for addressing the matrix elements, the plurality of levels being provided on outputs distributed substantially along the length of the one edge;
a group of switches associated with, and located at, each output of the voltage level generator circuit; and
an output bus arranged alongside the one edge and having the first number (X) of lines, the group of switches selectively coupling the associated voltage level generator circuit output to each line of the output bus.

2. A device as claimed in claim 1, wherein the multiple voltage level generator circuit comprises a resistor string extending alongside the length of the one edge.

3. A device as claimed in claim 1, wherein each group (30) of switches comprises a switch associated with each output bus line.

4. A device as claimed in claim 3, wherein the switches of each group are controlled by a corresponding bit of digital words based on the digital inputs to the digital to analogue converter circuitry.

5. A device as claimed in claim 4, wherein the digital words comprise the expansion of n-bit digital inputs to the digital to analogue converter circuitry into 2ⁿ bit words having a single non-zero bit.

6. A device as claimed in any preceding claim further comprising a multiplexer circuit for switching the first number (X) of outputs to a selected first number of matrix elements.

7. A device as claimed in claim 6, wherein the array of matrix elements are arranged in rows and columns, and the driver circuitry is arranged alongside a column edge of the array, and wherein the multiplexer circuit switches the first number of outputs to a selected subset of the columns.

8. A device as claimed in claim 7, wherein the multiplexer circuit comprises the output bus and switching elements which connect to the output bus and to each column.

9. A device as claimed in claim 1, further comprising decoder circuitry for converting n-bit digital inputs to the digital to analogue converter circuitry into 2ⁿ bit words having a single non-zero bit.

10. A device as claimed in claim 9, wherein the decoder circuitry is distributed along the length of the one edge and receives the first number of n-bit digital inputs (Data1-DataX), and generates the first number of 2ⁿ bit digital outputs, with corresponding bits of each of the first number of 2ⁿ bit digital outputs spatially grouped together.

11. A device as claimed in claim 1, comprising an active matrix liquid crystal display.

12. A device as claimed in claim 1, wherein the driver circuitry is integrated onto the same substrate as the array of matrix elements.
